(19) United States
(12) Patent Application Publication
(10) Pub. No.: US 2006/0112835 A1
(43) Pub. Date: Jun. 1, 2006

(54) Automatically basting cooking apparatus and associated method

(76) Inventor: John Healy, N. Hollywood, CA (US)

Correspondence Address: R. Neil Sudol, 714 Colorado Avenue, Bridgeport, CT, 06605-1601, US

(21) Appl. No.: 11/000,293

(22) Filed: Nov. 30, 2004

(51) Int. Cl. A47J 37/10

(52) U.S. Cl. 99/345

(57) ABSTRACT

An automatic basting apparatus includes a roasting pan having a food support surface and a chamber for receiving cooking fluids draining from food disposed on the support surface during a cooking operation. A supply tube mounted to the roasting pan communicates at one end with the chamber and has a spray nozzle disposed over the support surface. A container is disposed in the chamber is periodically pressurized to force fluid from the chamber into the delivery tube. A first air-pressure-operated valve closes a fluid inlet opening of the chamber at the beginning of a basting cycle, while a second air-pressure-operated valve enables communication between the container and the chamber.

### BACKGROUND OF THE INVENTION

This invention relates to an automatically basting cooking apparatus and to an associated method. More particularly, the present invention relates to a cooking pan and associated elements for use in an oven or barbecue grill, for automatically basting food items during a cooking operation.

Automatic basting devices are well known in the art. These devices are generally, if not universally, designed for use with barbecues or grills.

U.S. Pat. No. 6,582,745 discloses an outdoor cooking apparatus having a delivery tube that ends in a plurality of nozzles spaced from each other above a food supporting grill. A pump selectively activated by an electronic control circuit periodically injects a basting liquid into the delivery tube from a supply tube extending from a reservoir of basting liquid.

U.S. Pat. No. 5,066,505 relates to a cooking apparatus with a reservoir for cooking fluid, a cooking fluid spraying device, and means for transferring cooking fluid from the reservoir to the spraying device. The spraying device includes a pump for sucking cooking fluid from a sump below a cooking tray or grill and dispensing the cooking fluid onto food to be cooked.

U.S. Pat. No. 4,5819,89 describes a method and apparatus for rapid heating of foods to achieve different textures and tastes in the cooked food items. A heat exchange fluid comprising air containing dispersed cooking oil or fat is used to cook the food. A cooking chamber has a reservoir at a low point capable of holding cooking oil. The oil is dispersed into the closed heating chamber as a convective air flow is established within the heating chamber. A rotating support holds the food about an axis eccentrically positioned from the axis of an impeller which disperses the oil or fat and creates a positive flow of air within the chamber, to uniformly contact and fry the food.

U.S. Pat. No. 4,732,137 involves an apparatus for dispensing a liquid basting sauce. The apparatus includes an elongated sauce delivery tube having multiple spray nozzles suspended in spaced relationship along the length of the tube. The sauce delivery tube is mounted on the barbecue grill in a position above the food being cooked. Connected to one end of the delivery tube is a pressurized sauce supply bottle which contains the basting sauce. A timer-controlled injection valve connects the sauce supply bottle to the delivery tube, and upon activation of the valve by the selected timer device, sauce is injected under pressure into the tube and dispensed through the spray nozzles.

U.S. Pat. No. 6,047,694 relates to a cooking enhancement system for retarding excessive flame and creating a burst of spray to steam a product being cooked with an automatic means for distributing water onto an excessive flame activated by a photodetector that senses light from the excessive flame.

### OBJECTS OF THE INVENTION

A general object of the present invention is to provide an improved automatic basting apparatus.

A related object of the present invention is to provide an improved method for automatically basting food items.

It is a more particular object of the present invention to provide an automatically basting apparatus that may be used in a conventional domestic oven.

A related particular object of the present invention is to provide a method for automatically basting a food item being cooked in a conventional domestic oven.

An even more particular object of the present invention is to provide such a basting apparatus that is at least partially incorporated into a roasting pan or other cooking utensil.

Another object of the present invention is to provide such an apparatus wherein heat-sensitive parts such as electrical elements are disposed only outside the oven.

These and other objects of the present invention will be apparent from the drawings and descriptions herein. Although every object of the invention is believed to be attained by at least one embodiment of the invention, there is not necessarily any single embodiment that attains all of the objects of the invention.

### SUMMARY OF THE INVENTION

An automatic basting apparatus comprises, in accordance with the present invention, a pan having an outer surface provided with at least one opening, a basting fluid chamber communicating with the opening or openings to receive cooking fluids therefrom during a main portion of a cooking cycle, a basting fluid delivery tube extendable from the chamber to a point over a food support surface, and a pressurization assembly for periodically pressurizing the chamber to a pressure level above ambient air pressure to force cooking fluid from the chamber into the delivery tube during a basting portion of the cooking cycle.

Pursuant to another feature of the present invention, the pressurization assembly includes a valve for blocking the opening or openings to prevent cooking fluids from entering the chamber, the valve being responsive to air pressure. Because the valve is operated by air pressure, rather than a solenoid or other electronics, it may be located inside an oven chamber during cooking operations, without impairing the reliability or operability of the valve.

Pursuant to another feature of the present invention, the pressurization assembly includes a container attached to the pan for insertion therewith into an oven and further includes a pump operatively connected to the container for pumping gas (e.g., air) into the container during at least part of the basting portion of the cooking cycle. Preferably, the container shares a wall or panel with the basting fluid chamber. More preferably, the container is disposed inside the basting fluid chamber. In either case, the valve may be mounted to the container so as to be operated by pressure of air inside the container. A second valve may be provided for enabling communication between the container and the chamber during the basting portion of the cooking cycle and for preventing communication between the container and the chamber during the main portion of the cooking cycle. This second valve may also be operated by pressure of air inside the container.

The pressurization assembly automatically depressurizes the basting fluid chamber upon termination of the basting portion of the cooking cycle. Preferably, the second valve closes immediately upon deactivation of the pump. Air may leak gradually from the container after the closure of the second valve, for instance, via a pin hole provided in the air supply line. The first valve opens subsequently in response to a predetermined diminution in the pressure inside the container. Opening of the first valve permits air to exit the basting fluid chamber into the ambient environment and also permits further entry of basting or cooking fluids into the chamber.

An automatic basting apparatus comprises, in accordance with another feature of the present invention, a basting pan having a chamber for receiving cooking fluids draining from food disposed on a food support surface during a cooking operation. A supply tube mounted to the basting pan communicates at one end with the cooking fluid chamber and is provided at another end with a spray nozzle disposable over the food support surface. A valve is mounted at least indirectly to the basting pan for periodically blocking flow of cooking fluids to the chamber during the cooking operation. A gas supply assembly is operatively connected to the cooking fluid chamber for supplying gas thereto after a closing of the chamber by the valve means, to pressurize the chamber and force cooking fluids from the chamber into the supply tube. A control device is operatively connected at least to the gas supply assembly for periodically activating the gas supply assembly during the cooking operation.

This basting apparatus advantageously further comprises a container disposed inside the cooking fluid chamber, while the gas supply assembly includes a pump. The container is connected to the pump for receiving gas therefrom, while the valve is movably mounted to the container. A second valve may be movably mounted to the container for enabling communication between the container and the chamber upon a blocking of cooking fluid flow to the chamber by the first valve.

Pursuant to an additional feature of the present invention, the first valve is spring biased into an open position spaced from a wall of the chamber and the second valve is spring biased into a closure position on a wall of the container. The first valve has a spring constant less than a spring constant of the second valve so that the first valve requires less pressure to move than the second valve.

An automatic basting apparatus comprises, in accordance with a further embodiment of the present invention, a basting pan having a chamber for receiving cooking fluids draining from food disposed on a support surface during a cooking operation. A supply tube mounted to the basting pan communicates at one end with the chamber and has a dispensing nozzle disposable over the support surface. A container is disposed in the chamber, a pump (generally located outside of an oven) being operatively connected to the container for supplying gas thereto. At least one first valve element is operatively connected to the chamber for moving between a neutral position and an active position closing a fluid inlet opening of the chamber. At least one second valve element is operatively connected to the chamber for moving between a neutral position and an active position closing a gas outlet opening of the container. A timer is operatively connected to the pump for periodically activating the pump to pressurize the chamber. A first pressure level in the container moves the first valve into a closure position blocking entry of cooking fluid into the chamber, while a higher second pressure level in the container opens the second valve to pressurize the chamber and force cooking fluid therein into the supply tube.

An automatic basting apparatus comprises, in accordance with yet another embodiment of the present invention, a pan, a basting fluid delivery tube, a basting fluid chamber, a first valve, a container, a pump, and a second valve. The delivery tube extends from the pan to a point over a food support surface. The basting fluid chamber is disposed in the pan, below the support surface. The pan is provided with at least one opening for guiding drained cooking fluid into the chamber. The delivery tube communicates with the chamber. The first valve is mounted at least indirectly to the pan for selectively blocking flow of cooking fluids into and out of the chamber. The container is attached to the pan, while the pump is connected to the container for pressurizing the same. The first valve is operatively connected to the container so that the first valve operates to block the flow of cooking fluids into the chamber upon attainment of a first pressure level in the container. The second valve is connected to the container for enabling a pressurization of the chamber to move basting fluid therefrom into the delivery tube upon attainment of a second pressure level in the container. The second pressure level is greater than the first pressure level, so that the closure of the chamber to receiving cooking or basting fluid from the food support surface occurs prior to the pressurization of the chamber.

Preferably the pressurization container is disposed inside the basting fluid chamber, while the second valve is movable to alternatively open and close a communication passageway between the container and the chamber.

As discussed above, the valves may be spring biased, the first valve having a spring constant that is less than that of the second valve.

A method for basting a food item in an oven comprises, in accordance with the present invention, receiving basting fluid from a food item into a temporary storage chamber, periodically pressurizing a container disposed in the oven, blocking fluid flow from the support surface to the chamber upon attainment in the container of a first pressure level above ambient pressure, and pressurizing the chamber to force basting fluid therein into a delivery tube upon attainment in the container of a second pressure level higher than the first pressure level.

The blocking of fluid flow from the support surface to the chamber may include shifting a valve member from the container towards the support surface, while the pressurizing of the chamber may include shifting an additional valve member to open a communication path between the container and the chamber.

An automatic basting method comprises, in accordance with a different embodiment of the present invention, disposing a pan in an oven, cooking a food item disposed on a food support surface disposed above the pan in the oven, draining cooking fluids from the food item into a chamber disposed generally below the food support surface, alternately pressurizing and depressurizing the chamber, and during a pressurized condition of the chamber, moving cooking fluids from the chamber up a delivery tube and onto the food item.

In accordance with more particular features of the present invention discussed above, the pressurizing of the chamber includes pumping a gas into a container that is disposed at least in contact with the chamber, the pressurizing of the chamber further includes operating a first valve to block communication between the support surface and the chamber and operating a second valve to establish communication between the container and the chamber, and the operating of the valves is implemented via increasing gas pressure in the container.

### BRIEF DESCRIPTION OF THE DRAWING

FIG. 1 is a schematic cross-sectional view of an automatic basting device in accordance with the present invention.

FIG. 2 is a perspective view of another automatic basting device in accordance with the present invention.

FIG. 3 is an exploded view of a pan portion of the automatic basting device of FIG. 2.

FIG. 4 is a top plan view of the pan of FIG. 3.

FIG. 5 is a cross-sectional view taken along line V-V in FIG. 4.

FIG. 6 is a partial cross-sectional view, on a larger scale, also taken along line V-V in FIG. 4, showing a valve module included in the automatic basting pan of FIGS. 2-5.

FIG. 7 is a cross-sectional view solely of the valve module shown in FIG. 6.

FIG. 8 is a top plan view of the valve module of FIGS. 6 and 7.

FIG. 9 is a cross-sectional view, taken along line IX-IX in FIG. 4, showing a dispensing head of the automatic basting pan of FIGS. 2-5.

FIG. 10 is a schematic cross-sectional view of another automatic basting device in accordance with the present invention.

FIG. 11 is a cross-sectional view showing a portion of the device of FIG. 10 on a larger scale.

### DETAILED DESCRIPTION OF THE PREFERRED EMBODIMENTS

As depicted in FIG. 1, an automatic basting apparatus comprises a pan 10 having an upper fluid-catching surface 12. During a cooking process, pan 10 may be disposed inside a larger pan 11 having a food-supporting grill 13, so that surface 12 catches grease and other basting fluids that drip from the food item during the cooking process.

Pan 10 defines a basting fluid chamber 14 located below fluid-catching upper surface 12 and communicating with the fluid-catching surface to receive cooking fluids therefrom during a drainage portion of a cooking cycle. A basting fluid delivery tube 16 connected to pan 10 communicates at a lower end with chamber 14 and extends therefrom to a point over upper surface 12 and over grill 13 for dispensing basting fluid on a food item during a basting portion of the cooking cycle. A pressurization assembly 18 is operatively connected to basting fluid chamber 14 for periodically pressurizing the chamber to a pressure level above ambient air pressure to force cooking fluid from the chamber into delivery tube 16 during the basting portion of the cooking cycle.

Pressurization assembly 18 includes a first valve 20 for blocking communication between upper surface 12 and chamber 14 during the basting portion of the cooking cycle. Valve 20 is mounted to a container 22 disposed inside basting fluid chamber 14 and is operated by air pressure inside the container.

Pressurization assembly 18 further includes a pump 24 preferably disposed outside an oven during a cooking operation. Pump 24 is operatively connected to container 22 for pumping a gas such as air into the container during a periodic basting process. Pressurization assembly 18 includes a second valve 26 for enabling communication between container 22 and chamber 14 during the basting portion of the cooking cycle and for preventing communication between the container and the chamber during the drainage portion of the cooking cycle. Valve 26 is also operated by pressure of air inside pressurization container 22.

More specifically, valve 20 is operable during the basting portion of a cooking cycle to close a basting fluid inlet or opening 28 whereby basting or cooking fluids drain from fluid-catching upper surface 12 into chamber 14 during the drainage portion of a cooking cycle. Valve 20 is spring biased into a neutral position spaced from inlet or opening 28 and, upon the attainment of a first predetermined air pressure level inside container 22, moves into engagement with inlet or opening 28 to block the entry of fluid into chamber 14 and enable a pressurization of chamber by an opening of valve 26.

Pan 10 may include another opening 27, for instance, in a lower panel 29, through which basting fluid inside pan 11 enters chamber 14. In that event, valve 20 includes a valve part 31 that is spring biased into a neutral position spaced from inlet or opening 27 and, upon the attainment of a first predetermined air pressure level inside container 22, moves into engagement with inlet or opening 27 to block the entry of fluid into chamber 14 and enable a pressurization of chamber by an opening of valve 26.

Valve 26 is operable during the basting portion of a cooking cycle to open an aperture 30 in a wall or panel 32 of container 22, thereby permitting an escape of pressurizing gas from container 22 into an upper portion of chamber 14. The consequent pressurization of chamber 14 forces basting fluids from chamber 14 into delivery tube 16 and out through a dispensing nozzle 34 in a basting head 36 disposed at a free upper end of tube 16. Valve 22 is spring biased into a neutral closing aperture 30 and, upon the attainment of a second predetermined air pressure level inside container 22, moves out of engagement with wall or panel 32 to enable the passage of pressurization gas into chamber 14 from container 14. The spring (not illustrated ) of valve 26 is stiffer than the spring of valve 20, i.e., has a higher spring constant, so that valve 26 shifts from its neutral or resting position only after valve 20 has shifted into engagement with inlet or opening 28 to block the entry of cooking/basting fluid into chamber 14 from upper surface 12.

Under the control of a timer 40, pump 24 periodically pressurizes container 22. In response to a signal from timer 40, pump 24 moves air from the ambient space through a tube or conduit 42 extending to container 22. When the pressure inside container 22 reaches the first predetermined pressure level, valve 20 moves to close chamber 14 to the ambient space. (Inlets or openings 27 and 28 are the only avenue of communication between chamber 14 and the external environment, other than through container 14, tube 42 and pump 24.) After the closure of inlets or openings 27 and 28, pump 24 continues to pump air into container 22, increasing the pressure therein. When the pressure inside container 22 subsequently reaches the second predetermined pressure level, valve 26 moves to open aperture 30, thus enabling air to move from container 22 into chamber 14 to pressurize the chamber and force the dispensing of basting fluid from delivery tube 16.

After a pre-established interval, timer 40 deactivates pump 24 to depressurize container 22 through tube 42 to ambient space outside of an oven. Tube 42 may be provided with a pin hole (not illustrated) for enabling a controlled or measured depressurization of container 22. Upon the attainment of the second predetermined pressure level inside container 22, valve 26 shifts to close aperture 30. This shifting of valve 26 and closure of aperture 30 preferably occurs substantially immediately upon the deactivation of pump 24. Upon a subsequent attainment of the first predetermined pressure level, valve 20 shifts towards container 22, thereby enabling a flow of cooking fluids from upper surface 12 and pan 11 to chamber 14.

Timer 40 commences another cooking cycle which is divided into a basting subcycle and a longer subcycle during which cooking fluids drain into chamber 14 from upper surface 12 and surrounding pan 11. The terms “cooking fluid” and “basting fluid” are used interchangeably herein to designate liquid that drips from a food product during an oven-type cooking process. The liquid may include natural components such as melted fats and added components such as flavorings and liquids.

The apparatus shown in FIG. 1 implements an automatic basting process in an oven, particularly a domestic oven, wherein basting fluid is received from fluid-catching upper surface 12 and pan 11 into temporary storage chamber 14, container 22 is periodically pressurized, fluid flow from upper surface 12 and pan 11 to chamber 14 is blocked upon attainment in the container of a first pressure level above ambient pressure, and chamber 14 is pressurized to force basting fluid therein into delivery tube 16 upon attainment in the container of a second pressure level higher than the first pressure level. The blocking of fluid flow from upper surface 12 and pan 11 to chamber 14 includes shifting valve member 20 from container 22 towards upper surface 12 and lower panel 29, while the pressurizing of chamber 14 includes shifting valve member 26 to open a communication path between container 22 and chamber 14.

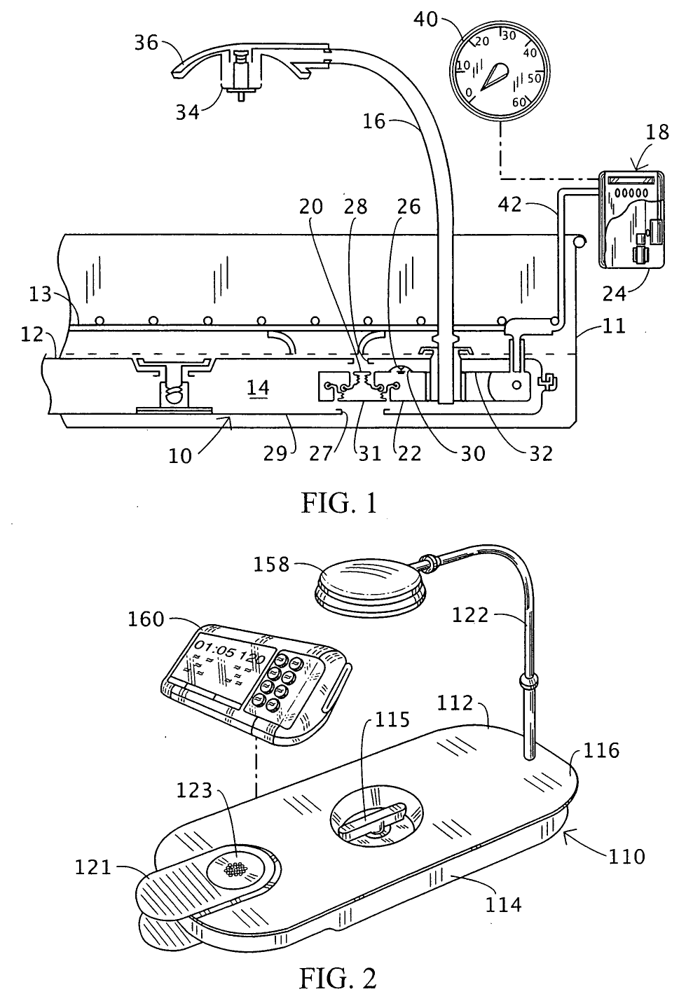

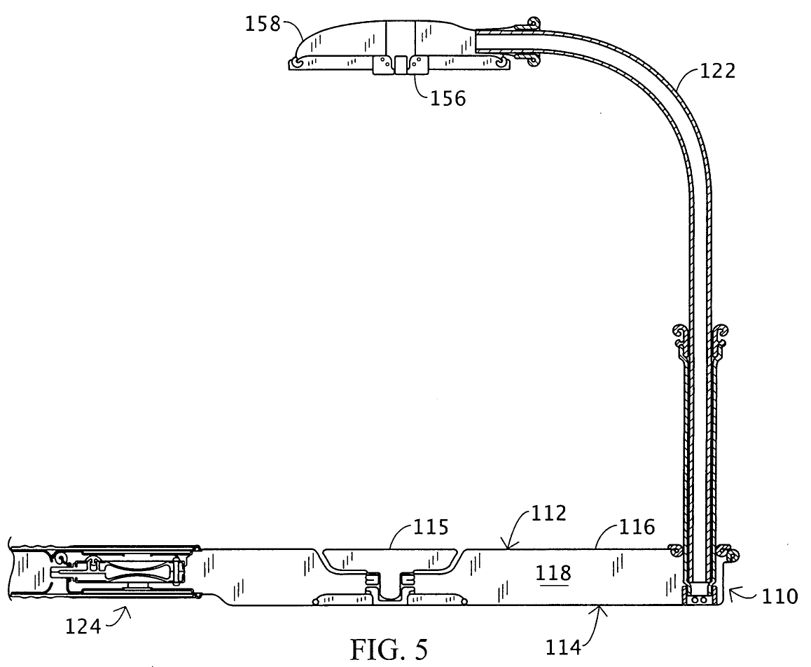

As depicted in FIGS. 2-5, another automatic basting apparatus similar to that shown in FIG. 1 comprises a pan 110 including an upper pan part 112 and a lower pan part 114 that are releasably secured to one another via a pan lock 115. Upper pan part 112 has an upper fluid-catching surface 116. During a cooking process, pan 110 may be disposed inside a larger pan 11 (FIG. 1), so that surface 116 catches grease and other basting fluids that drip from the food item during the cooking process.

Pan 110 defines a basting fluid chamber 118 located below upper pan part 112 and communicating with fluid-catching surface 116 via an opening 120 to receive cooking fluids therefrom during a drainage portion of a cooking cycle. Opening 120 is covered by a filter element 121 provided with an array of perforations 123 (see FIG. 4) generally aligned with opening 120. A basting fluid delivery tube 122 connected to pan 110 communicates at a lower end with chamber 118 and extends therefrom to a point over upper surface 116 and over grill 13 (FIG. 1) for dispensing basting fluid on a food item during a basting portion of the cooking cycle. A pressurization assembly 124 is operatively connected to basting fluid chamber 118 for periodically pressurizing the chamber to a pressure level above ambient air pressure to force cooking fluid from the chamber into delivery tube 122 during the basting portion of the cooking cycle.

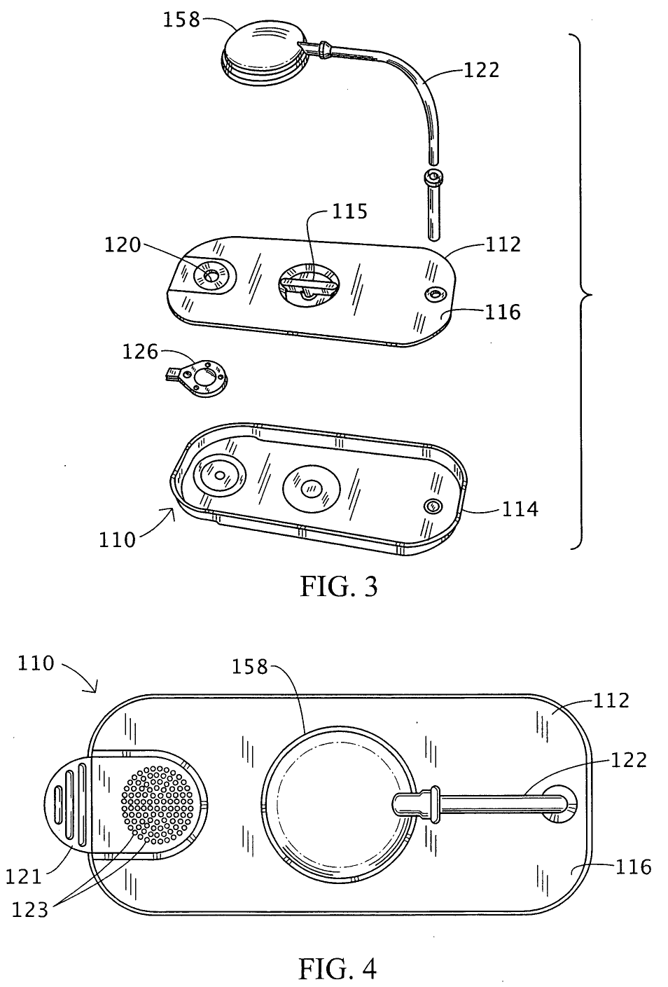

Pressurization assembly 124 includes a valve module 126 (FIGS. 3 and 5-8) having a first diaphragm-type rubber valve part 128 for blocking opening 120 to prevent flow of cooking fluids from upper surface 116 to chamber 118 during the basting portion of the cooking cycle. Valve module 126 is disposed inside basting fluid chamber 118 and functions in part as a pressurization container.

Pan 110 includes another opening 132, in lower pan part 114, through which basting fluid inside pan 11 (FIG. 1) enters chamber 118. Valve module 126 includes a second diaphragm-type rubber valve part 134 that is spring biased into a neutral position spaced from inlet or opening 132 and, upon the attainment of a first predetermined air pressure level inside valve module or pressurization container 126, moves into engagement with inlet or opening 132 to block the entry of fluid into chamber 118 and enable a pressurization of chamber by an opening of a valve 136.

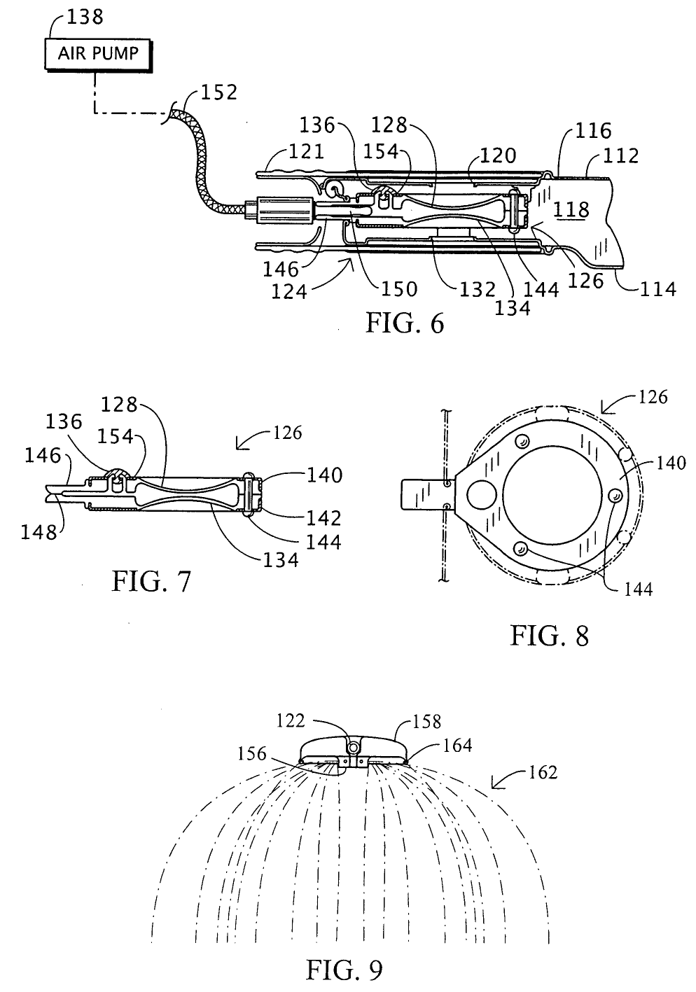

Pressurization assembly 124 further includes a pump 138 (FIG. 6) preferably disposed outside an oven during a cooking operation. Pump 138 is operatively connected to valve module 126 for pumping a gas such as air into the module during a periodic basting process. Valve 136 enables communication between module 126 and chamber 118 during the basting portion of the cooking cycle and prevents communication between the module and the chamber during the drainage portion of the cooking cycle. Valve 136 is also operated by pressure of air inside pressurization valve module 126.

Valves 128 and 134 are operable during the basting portion of a cooking cycle to close basting fluid inlets or openings 120 and 132 whereby basting or cooking fluids flow into chamber 118 during the drainage or chamber-filling portion of a cooking cycle. Like valve 134, valve 128 is spring biased into a neutral position spaced from inlet or opening 120 and, upon the attainment of a first predetermined air pressure level inside valve module 126, moves into engagement with inlet or opening 120 to block the entry of fluid into module 126 and enable a pressurization of chamber by an opening of valve 136.

Valve module 126 has an upper casing part 140 and a lower casing part 142 that are made of stainless steel and connected to one another by rivets 144. An inlet port 146 is provided with a flexible seal 148 for sealingly receiving a plug connector 150 of a hose 152 extending to pump 138.

Valve 136 is operable during the basting portion of a cooking cycle to open an aperture 154 in upper casing part 140 of valve or pressurization module 126, thereby permitting an escape of pressurizing gas from module 126 into an upper portion of chamber 118. The consequent pressurization of chamber 118 forces basting fluids from chamber 118 into delivery tube 122 and out through a dispensing nozzle 156 in a basting head 158 at the free upper end of tube 122. Valve 136 is spring biased into a neutral closing aperture 154 and, upon the attainment of a second predetermined air pressure level inside module 126, moves out of engagement with upper casing part or panel 140 to enable the passage of pressurization gas into chamber 118 from module 126. The spring constant of valve 136 is stiffer or larger than the spring constant of valve parts 128 and 134, so that valve 136 shifts from its neutral or resting position only after valve parts 128 and 134 have shifted into engagement with inlets or openings 120 and 132, respectively, to block the entry of cooking/basting fluid into chamber 118.

Pump 138 is responsive to a timer/control unit 160 to periodically pressurize valve module 126. In response to a signal from timer/control unit 160, pump 138 moves air from the ambient space through tube or hose 152. When the pressure inside module 126 reaches the first predetermined pressure level, valves 128 and 134 move to close chamber 118 to the ambient space. (Inlets or openings 120 and 132 are the only avenue of communication between chamber 118 and the external environment, other than through valve module 126, tube or hose 152 and pump 138.) After the closure of inlets or openings 120 and 132, pump 138 continues to pump air into valve module 126, increasing the pressure therein. When the pressure inside valve module 126 subsequently reaches the second predetermined pressure level, valve 136 moves to open aperture 154, thus enabling air to move from valve module 126 into chamber 118 to pressurize the chamber and force the dispensing of basting fluid via delivery tube 122 and nozzle 156.

After a pre-established interval, timer/control unit 160 deactivates pump 138 to depressurize valve module 126. Air then moves from module 126 through tube or hose 156 to the ambient space, outside of an oven. Tube or hose 156 may be provided with a pin hole (not illustrated) for enabling a controlled or measured depressurization of valve module 126. Upon the attainment of the second predetermined pressure level inside module 126, valve 136 shifts to close aperture 154. This shifting of valve 136 and closure of aperture 154 preferably occurs substantially immediately upon the deactivation of pump 138. Upon a subsequent attainment of the first predetermined pressure level, valves 128 and 134 shift inwardly to unplug openings 120 and 132, thereby dropping pressure in chamber 118 to ambient or atmospheric pressure enabling a flow of cooking fluids into chamber 118.

Timer/control unit 160 commences another cooking cycle which is divided into a basting subcycle and a longer subcycle during which cooking fluids enter chamber 118 from upper pan surface 116 and surrounding pan 11 (FIG. 1).

The apparatus shown FIGS. 2-9 implements an automatic basting process in an oven, particularly a domestic oven, wherein basting fluid is received from fluid-catching upper surface 116 and pan 11 (FIG. 1) into temporary storage chamber 118, valve module 126 is periodically pressurized, fluid flow into chamber 118 is blocked upon attainment in the valve module of a first pressure level above ambient pressure, and chamber 118 is pressurized to force basting fluid therein into delivery tube 122 upon attainment in the valve module of a second pressure level higher than the first pressure level. The blocking of fluid flow into chamber 118 includes shifting valve part 128 of module 126 towards opening 120 and valve part 134 towards opening 132 in lower pan part 114, while the pressurizing of chamber 118 includes shifting valve member 136 to open a communication path between module 126 and chamber 118.

Delivery tube 122 may be provided with telescoping parts (not shown) for permitting adjustment in the position of basting head 158, both vertically and laterally. FIG. 9 shows a spray pattern 162 of nozzle 156 as modified by a rim 164 of basting head 158.

Each pump 24 and 138 or its respective tube or hose 42 or 152 may be provided with a pin hole to bleed down the pressure in container 22 or 126 after pump deactivation. The pin hole would be small enough to allow the respective pump to reach operating pressure with ease but still bleed down the pressure once the pump has been turned off.

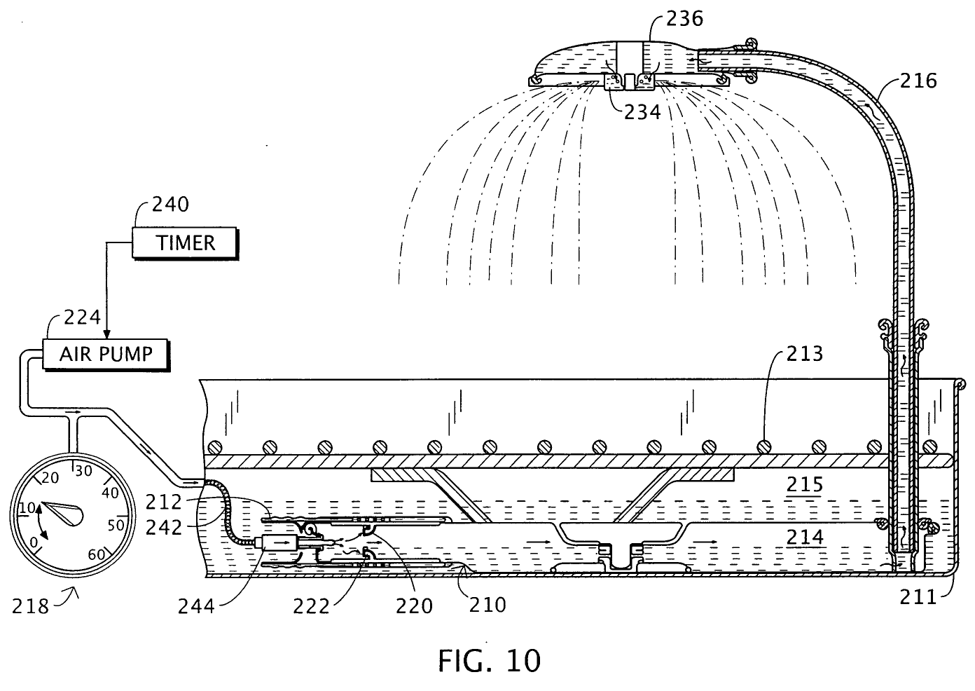

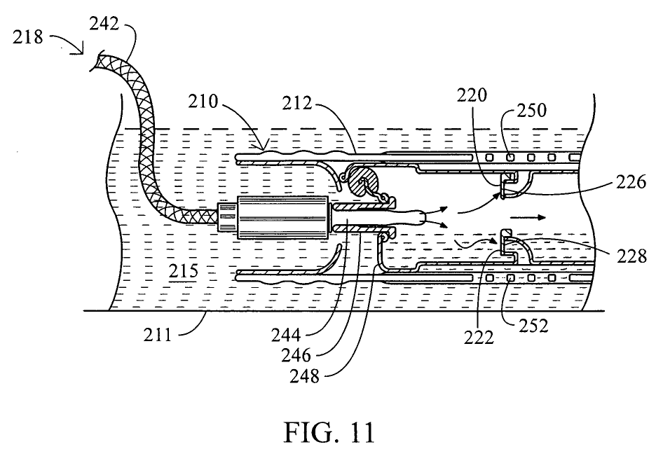

As depicted in FIGS. 10 and 11, another automatic basting apparatus comprises a pan 210 having an upper fluid-catching or -guiding surface 212. During a cooking process, pan 210 is disposed inside a larger pan 211 having a food-supporting grill 213, so that surface 212 catches grease and other basting fluids that drip from the food item during the cooking process. In some cases, as indicated in FIG. 10, the grease and other cooking fluids may be sufficiently voluminous to form a reservoir 215 deep enough that pan 210 is submerged in the fluids.

Pan 210 defines a basting fluid chamber 214 located below upper surface 212 and communicating with that surface and/or with reservoir 215 to receive cooking fluids during a chamber-filling portion of a cooking cycle. A basting fluid delivery tube 216 connected to pan 210 communicates at a lower end with chamber 214 and has an upper end disposed over upper surface 212 and over grill 213 for dispensing basting fluid on a food item during a basting portion of the cooking cycle. A pressurization assembly 218 is operatively connected to basting fluid chamber 214 for periodically pressurizing the chamber to a pressure level above ambient air pressure to force cooking fluid from the chamber into delivery tube 216 during the basting portion of the cooking cycle.

Pressurization assembly 218 includes a first valve 220 for blocking communication between upper surface 212 and chamber 214, and a second valve 222 for blocking communication between a lower part or reservoir 215 and chamber 214, during the basting portion of the cooking cycle. Valves 220 and 222 aremounted to pan 210 and are operated by air pressure inside chamber 214.

Pressurization assembly 218 further includes a pump 224 preferably disposed outside an oven during a cooking operation. Pump 224 is operatively connected to chamber 214 for pumping a gas such as air into the chamber during a periodic basting process.

Valves 220 and 222 are operable during the basting portion of a cooking cycle to close respective basting fluid inlets or openings 226 and 228 whereby basting or cooking fluids enter from upper surface 212 and/or reservoir 215 into chamber 214 during chamber-filling portion of a cooking cycle. Valves 220 and 222 may be freely pivoting flaps or membranes that cover inlets or openings 226 and 228 upon a pressurization of chamber 214 by pressurization assembly 218 and that permit the entry of cooking or basting fluids into chamber 214 via inlets or openings 226 and 228 upon a reduction of the air pressure level inside chamber 214.

Upon a closure of valves 220 and 222 by pressurization assembly 218, further pressurization of chamber 214 forces basting fluids from chamber 214 into delivery tube 216 and out through a dispensing nozzle 234 in a basting head 236 disposed at a free upper end of tube 216.

Under the control of a timer 240, pump 224 periodically pressurizes chamber 214. In response to a signal from timer 240, pump 224 moves air from the ambient space through a tube or conduit 242 extending to a plug member 244. At the beginning of a cooking process, a user inserts plug member 244 into a socket 246 provided in a sidewall 248 of pan 210.

After lapse of a pre-established interval after pump activation, timer 240 controls pump 224 to enable a depressurization of chamber 214. Pump 224 may be reversible so as to actively remove from chamber 214 by pump 224. Subsequently, timer 240 commences another cooking cycle which is divided into a basting subcycle and a longer subcycle during which cooking fluids drain into chamber 214 from upper surface 212 and reservoir 215.

Inlets or openings 226 and 228 are the only avenue of communication between chamber 214 and the external environment, other than through container tube 242 and tube 216. A pair of filter screens 250 and 252 are provided on pan 210 over inlets or openings 226 and 228 to block larger food particles from entering chamber 214.

The apparatus shown in FIGS. 10 and 11 implements an automatic basting process in an oven, particularly a domestic oven, wherein basting fluid is received from fluid-catching upper surface 212 and pan 21 1 into temporary storage chamber 214, the chamber is periodically pressurized, fluid flow through openings 226 and 228 into chamber 214 is blocked upon pressurization of the chamber, and basting fluid therein is forced into delivery tube 216.

Timer/control unit 160 and timer 240 may each be realized by an integrated circuit including a memory for storing a basting sequence selection. A stored basting sequence may include temperature and time parameters, enabling a user to use the same basting sequence at a later time, without a need for resetting or reselecting the basting parameters. The stored sequences may be programmed by the user or, alternatively, at the factory. In either case, timer/control unit 160 and timer 240 include a keypad or data entry interface (not separately shown) for the input of basting sequence data and basting instructions.

Predetermined basting sequences loaded into the memory at the factory may vary in accordance with such parameters as the type of food item (beef, chicken, lamb, etc.), the degree of cooking or taste (rare, medium rare, medium, well done, etc.), and the weight of the food item (one pound, two pounds, etc.). A user undertaking a roasting operation may program a basting sequence in accordance with the particular parameters of the roasting operation by merely entering an appropriate sequence of three numbers via the keypad. Alternatively, the keypad may be designed with keys corresponding to the different kinds of food items, the different tastes, and the different weights. In the latter case, the user simply selects a food item such Beef, a taste such as Well-Done, and a weight such as Two Pounds, and sets the alarm.

In the case of preprogrammed basting operations, with the user simply entering numbers in a 3 digit sequence, an instruction card may be provided that indicates the coding for the various basting parameters. Shown below is an example of how the 3 categories could appear on the instruction card.

| Meat | Taste | Weight (lbs/kg) |
|---|---|---|
| Chicken - 1 | Well Done - 1 | 1—1 |
| Turkey - 2 | Medium - 2 | 2—2 |
| Veal - 3 | Medium Rare - 3 | 3—3 |
| Beef - 4 | Rare - 4 | 4—4 |
| Pork - 5 | | 5—5 |
| Lamb - 6 | | 6—6 |
| Etc . . . | Etc . . . | Etc . . . |

If the user wishes to cook Beef to a taste of Medium Rare with a weight of 2 Pounds, she would input the code 4-3-2. This would cause the built-in memory to set the appropriate basting sequences, temperature setting and time setting for that particular item to be cooked. The instruction card may be located in a slot on a control box.

Timer, 40, timer/control unit 160, and timer 240 can be programmed to periodically energize pumps 24, 138, and 224 during a basting cycle. For example, pump 24, 138, 224 may be turned on and off at three-second intervals (3 seconds on, 3 seconds off) during a basting cycle of 30 to 60 seconds. The basting coverage then expands and contracts wit hthe fluctuating pressure, resulting in a more effective supply of basting juices to the food.

Although the invention has been described in terms of particular embodiments and applications, one of ordinary skill in the art, in light of this teaching, can generate additional embodiments and modifications without departing from the spirit of or exceeding the scope of the claimed invention. For example, a basting-fluid container might be located outside an oven for receiving basting fluid via a conduit from a food support surface. The container is periodically pressurized to force basting fluid into a delivery tube extending back inside the oven.

In a modified embodiment of the invention, pressurization of a basting-fluid container disposed inside an oven may be achieved by conveying compressed air or other gas from a pre-pressurized source outside the oven.

Accordingly, it is to be understood that the drawings and descriptions herein are proffered by way of example to facilitate comprehension of the invention and should not be construed to limit the scope thereof.

What is claimed is:

1. An automatic basting apparatus comprising:
a pan having an outer surface provided with at least one opening;
a basting fluid chamber communicating with said opening to receive cooking fluids therefrom during a filling portion of a cooking cycle;
a basting fluid delivery tube extending from said chamber to a point over a food support surface; and
a pressurization assembly mounted at least partially to said pan for periodically pressurizing said chamber to a pressure level above ambient air pressure to force cooking fluid from said chamber into said delivery tube during a basting portion of said cooking cycle.

2. The apparatus defined in claim 1 wherein said pressurization assembly includes a valve for blocking said opening, said valve being responsive to air pressure.

3. The apparatus defined in claim 2 wherein said pressurization assembly includes a container attached to said pan for insertion therewith into an oven, further including a pump operatively connected to said container for pumping gas into said container during at least a part of said basting portion of said cooking cycle.

4. The apparatus defined in claim 3 wherein said valve is connected to said container so as to be operated by pressure of air inside said container.

5. The apparatus defined in claim 4 wherein said valve is a first valve, said pressurization assembly further including a second valve for enabling communication between said container and said chamber during at least part of said basting portion of said cooking cycle and for preventing communication between said container and said chamber during said filling portion of said cooking cycle.

6. The apparatus defined in claim 5 wherein said second valve is operated by pressure of air inside said container.

7. The apparatus defined in claim 3 wherein said container is disposed at least partially inside said chamber.

8. The apparatus defined in claim 1 wherein said pressurization assembly includes a container attached to said pan for insertion therewith into an oven, further including a pump operatively connected to said container for pumping gas into said container during at least part of said basting portion of said cooking cycle.

9. The apparatus defined in claim 8 wherein said container is disposed at least partially inside said chamber.

10. The apparatus defined in claim 9 wherein said container is disposed substantially entirely inside said chamber.

11. The apparatus defined in claim 1 wherein said pressurization assembly includes a control unit with a memory storing different basting sequences or cycles, said pressurization assembly further including an actuation component operatively connected to said control unit and said memory for selecting a basting sequence or cycle from among the stored basting sequences or cycles.

12. The apparatus defined in claim 1 wherein said pressurization assembly includes means for automatically depressurizing said chamber upon termination of said basting portion of said cooking cycle.

13. The apparatus defined in claim 1 wherein said chamber is disposed in said pan below a food support surface, said pressurization assembly including a container with a first valve for selectively closing said opening to block flow of cooking fluids to said chamber upon attainment of a first pressure level in said container, said container having a second valve for selectively enabling communication between said container and said chamber upon attainment of said second pressure level in said container, said pressurization assembly further including a pump connected to said container for pressurizing same, said second pressure level being greater than said first pressure level.

14. The apparatus defined in claim 1 wherein said chamber is connected to said pan so as to be disposable in an oven together with said pan.

15. An automatic basting apparatus comprising:
a basting pan, said basting pan having a chamber for receiving cooking fluids draining from food disposed on a food support surface during a cooking operation;
a supply tube mounted to said basting pan, said supply tube communicating at one end with said chamber, said supply tube having a nozzle disposable over said support surface;
valve means mounted to said basting pan for periodically blocking flow of cooking fluids to said chamber during said cooking operation;
gas supply means operatively connected to said chamber for supplying gas to said chamber after a closing of said chamber by said valve means, to pressurize said chamber and force cooking fluids from said chamber into said supply tube; and
control means operatively connected at least to said gas supply means for periodically activating same during said cooking operation.

16. The basting apparatus defined in claim 14, further comprising a container disposed inside said chamber, said gas supply means including a pump, said container being connected to said pump for receiving gas therefrom, said valve means including a first valve movably mounted to said container, further comprising a second valve movably mounted to said container for enabling communication between said container and said chamber upon a blocking of cooking fluid flow to said chamber by said first valve.

17. The basting apparatus defined in claim 15 wherein said first valve is spring biased into an open position spaced from a wall of said chamber and said second valve is spring biased into a closure position on a wall of said container, said first valve having a spring constant less than a spring constant of said second valve so that said first valve requires less pressure to move than said second valve.

18. An automatic basting apparatus comprising:
a basting pan having a chamber for receiving cooking fluids draining from food disposed on a food support surface during a cooking operation;
a supply tube mounted to said basting pan, said supply tube communicating at one end with said chamber, said supply tube having a nozzle disposable over said support surface;
a container disposed in said chamber;
a pump operatively connected to said chamber for supplying gas to said chamber;
at least one first valve element operatively connected to said chamber for moving between a neutral position and an active position closing a fluid inlet opening of said chamber;
at least one second valve element operatively connected to said chamber for moving between a neutral position and an active position opening a gas outlet opening of said container; and
a timer operatively connected to said pump for periodically activating same to pressurize said chamber,
a first pressure level in said container moving said first valve into a closure position blocking entry of cooking fluid into said chamber,
a higher second pressure level in said container opening said second valve to pressurize said chamber and force cooking fluid therein into said supply tube.

19. An automatic basting apparatus comprising:
a pan;
a basting fluid delivery tube extendable from said pan to a point over a food support surface;
a basting fluid chamber in said pan, said pan being provided with at least one opening communicating with said chamber, said delivery tube communicating with said chamber;
a first valve mounted at least indirectly to said pan for selectively blocking said opening to prevent flow of cooking fluids to said chamber;
a container attached to said pan;
a pump connected to said container for pressurizing same, said first valve being operatively connected to said container so that said first valve operates to block flow of cooking fluid to said chamber upon attainment of a first pressure level in said container; and
a second valve connected to said container for enabling a pressurization of said chamber to move basting fluid therefrom into said delivery tube upon attainment of a second pressure level in said container, said second pressure level being greater than said first pressure level.

20. The basting apparatus defined in claim 18 wherein said container is disposed inside said chamber.

21. The basting apparatus defined in claim 19 wherein said second valve is movable to alternatively open and close a communication passageway between said container and said chamber.

22. The basting apparatus defined in claim 18 wherein said first valve and said second valve include spring biased valve members, said first valve and said second valve having spring constants, the spring constant of said second valve being greater than the spring constant of said first valve.

23. A method for basting a food item in an oven, comprising:
receiving basting fluid into a temporary storage chamber;
periodically pressurizing a container disposed in said oven;
upon attainment in said container of a first pressure level above ambient pressure, blocking fluid flow from to said chamber; and
upon attainment in said container of a second pressure level higher than said first pressure level, pressurizing said chamber to force basting fluid therein into a delivery tube.

24. The method defined in claim 22 wherein the blocking of fluid flow to said chamber includes shifting a valve member away from said container.

25. The method defined in claim 23 wherein the pressurizing of said chamber includes shifting an additional valve member to open a communication path between said container and said chamber.

26. The method defined in claim 22 wherein said container is disposed inside said chamber.

27. The method defined in claim 22 wherein the pressurizing of said container includes operating a pump disposed outside the oven.

28. An automatic basting method comprising:
disposing a pan in an oven;
cooking a food item disposed on a food support surface in said oven;
draining cooking fluids from said food item into a chamber disposed below said surface;
alternately pressurizing and depressurizing said chamber; and
during a pressurized condition of said chamber, moving cooking fluids from said chamber up a delivery tube and onto said food item.

29. The method defined in claim 27 wherein the pressurizing of said chamber includes pumping a gas into a container that is disposed at least in contact with said chamber.

30. The method defined in claim 28 wherein the pressurizing of said chamber includes operating a valve for blocking flow of cooking fluids into said chamber.

31. The method defined in claim 29 wherein said valve is connected to said container so as to shift in response to pressure of air inside said container.

32. The method defined in claim 30 wherein said valve is a first valve, the pressurizing of said container further including operating a second valve to establish communication between said container and said chamber.

33. The method defined in claim 31 wherein said second valve shifts in response to pressure of air inside said container.

34. The method defined in claim 28 wherein said container is disposed at least partially inside said chamber.

35. An automatic basting apparatus comprising:
a basting fluid delivery tube for delivering a basting fluid to a point over a food support surface;
a fluid flow assembly operatively connected to said delivery tube to force cooking fluid into said delivery tube during a basting portion of said cooking cycle; and
control componentry operatively connected to said fluid flow assembly for periodically activating said fluid flow assembly during a cooking process, said control componentry including a memory storing different basting sequences or cycles, said control unit further including an actuation component operatively connected to said memory for selecting a basting sequence or cycle from among the stored basting sequences or cycles.

36. The apparatus defined in claim 35 wherein said fluid flow assembly includes a basting fluid chamber connected to said delivery tube and further includes a pressurization assembly operatively connected to said chamber for periodically pressurizing said chamber to a pressure level above ambient air pressure to force cooking fluid from said chamber into said delivery tube.

37. The apparatus defined in claim 35 wherein said fluid flow assembly includes a pump.
